(19) United States
(12) Patent Application Publication
(10) Pub. No.: US 2025/0313042 A1
(43) Pub. Date: Oct. 9, 2025

(54) SPRING TIRE OR SPRING WHEEL

(71) Applicant: Luhao LENG, Xiamen (CN)

(72) Inventor: Luhao LENG, Xiamen (CN)

(21) Appl. No.: 19/088,634

(22) Filed: Mar. 24, 2025

(30) Foreign Application Priority Data
Apr. 3, 2024 (CN) 202410403695.1

(51) Int. Cl. B60C 7/18; B60B 9/06; B60C 7/14; B60C 7/24

(52) U.S. Cl. CPC B60C 7/18; B60B 9/06; B60C 7/146; B60C 7/24

(57) ABSTRACT

A spring tire or a spring wheel includes a hub, a plurality of tapered springs, a plurality of retainers, and an elastic outer tire tread. The plurality of tapered springs are pre-compressed and mounted on the hub through the plurality of retainers, and inner side surfaces of the plurality of retainers are pressed on and abut the plurality of tapered springs. The inner side surfaces of the plurality of retainers are buckled to the hub, and outer side surfaces of the plurality of retainers abut an inner side surface of the elastic outer tire tread.

### RELATED APPLICATIONS

This application claims priority to Chinese patent application number 202410403695.1, filed on Apr. 3, 2024. Chinese patent application number 202410403695.1 is incorporated herein by reference.

### FIELD OF THE DISCLOSURE

The present disclosure relates to the technical field of tire components, and more specifically relates to a spring tire or a spring wheel.

### BACKGROUND OF THE DISCLOSURE

Currently, most automotive tires are pneumatic tires. Inflatable wheels possess load-bearing, shock absorption, and force transmission (acceleration, braking, and directional change) capabilities, making them particularly suitable for various vehicles, especially bicycles, motorcycles, cars, and trucks. The shock absorption capability of tires also finds applications in other areas, such as carts used for transporting medical equipment or sensitive electronics. However, pneumatic tires are prone to punctures by sharp objects, leading to blowouts and rollover accidents, particularly in remote areas where repairs are impossible, severely compromising mobility. Consequently, some puncture-resistant tires (non-pneumatic) have emerged, such as rubber tires embedded with steel wires that rely on wire deformation for shock absorption. These designs use movable spokes on the rim that adapt to wire deformation, but such spokes only provide vertical movement at ground contact points and offer no shock absorption elsewhere on the rim. Damaged components in these tires cannot be replaced. While solid tires used in run-flat systems avoid puncture risks, they depend on ground-contact compression for load-bearing. Such tires are heavy, rigid, and lack the impact absorption of pneumatic wheels. When made more flexible, existing non-pneumatic tires compromise either load capacity or durability compared to pneumatic counterparts.

To address these limitations, Chinese Patent CN1284446A proposed a spring-type non-pneumatic wheel structure using radial coil springs and spring plate rims to replace conventional inner tubes. However, in this design, springs on radial surfaces are constrained by inner and outer spring plate rims, resulting in inadequate axial torsion resistance that impairs effective force buffering and distribution. Moreover, localized spring damage would compromise functionality of the entire.

### BRIEF SUMMARY OF THE DISCLOSURE

The present disclosure discloses a spring tire or a spring wheel designed to address the technical deficiencies of spring-type non-pneumatic wheels in the aforementioned background.

In order to solve the above technical problems, the present disclosure provides a spring tire or a spring wheel comprising a hub, a plurality of tapered springs, a plurality of retainers, and an elastic outer tire tread. The plurality of tapered springs are pre-compressed and mounted on the hub through the plurality of retainers, and inner side surfaces of the plurality of retainers are pressed on and abut the plurality of tapered springs. The inner side surfaces of the plurality of retainers are buckled to the hub, and outer side surfaces of the plurality of retainers abut an inner side surface of the elastic outer tire tread.

In a preferred embodiment, each of the plurality of retainers comprises two buckling claws symmetrically sleeved on a circumferential surface of the hub, a buckling shoulder perpendicular to the two buckling claws and having a height difference relative to the two buckling claws, and two buckling arms, and two ends of each of the two buckling arms are respectively connected to a corresponding one of the two buckling claws and the buckling shoulder.

In a preferred embodiment, the buckling shoulder presses a corresponding one of the plurality of tapered springs radially inward, and the plurality of tapered springs are pre-compressed springs. The plurality of tapered springs generate elastic resetting forces due to being pressed by the buckling shoulders of the plurality of retainers.

In a preferred embodiment, a buckling connection between each of the plurality of retainers and the hub is achieved by an inserting part and a receiving part, the inserting part is configured as two rib rings on a circumferential surface of the hub, and the receiving part is configured as one or more buckling strips on each of two buckling claws.

In a preferred embodiment, the one or more buckling strips are two buckling strips, and the two buckling strips are symmetrically arranged on a corresponding one of the two rib rings and disposed on an inner side surface of a corresponding one of the two buckling claws adjacent to the hub.

In a preferred embodiment, a buckling connection between each of the plurality of retainers and the hub is achieved by an inserting part and a receiving part, the inserting part is configured as a U-shaped part on each of two buckling claws, and the receiving part is configured as a second buckling groove arranged on a circumferential surface of the hub.

In a preferred embodiment, a position-limiting member and a position-limiting matching member are respectively located on the inserting part and the receiving part. When the inserting part and the receiving part are buckled to each other, the position-limiting member and the position-limiting matching member are interlocked with each other.

In a preferred embodiment, the position-limiting member is an inserting block disposed on the inserting part, and the position-limiting matching member is an inserting groove located on the receiving part.

In a preferred embodiment, a side of the buckling shoulder of each of the plurality of retainers facing the corresponding one of the plurality of tapered springs comprises a third buckling groove configured to be sleeved on the corresponding one of the plurality of tapered springs.

In a preferred embodiment, a small end face of each of the plurality of tapered springs is embedded in a corresponding one of a plurality of first buckling grooves on the hub, and a large end face of each of the plurality of tapered springs is embedded in a corresponding one of the third buckling grooves. Each of the plurality of tapered springs supports a corresponding one of the buckling shoulders with a predetermined initial compression force.

In a preferred embodiment, a plurality of position-limiting buckling strips are evenly distributed on the inner side surface of the elastic outer tire tread facing the plurality of retainers, adjacent position-limiting buckling strips of the plurality of position-limiting buckling strips form a fourth buckling groove, and the fourth buckling groove is configured to inhibit a relative swing of one end of a corresponding one of the plurality of retainers away from of the hub.

In a preferred embodiment, root portions of the plurality of position-limiting buckling strips are connected to the inner side surface of the elastic outer tire tread, and end portions of the plurality of position-limiting buckling strips extend toward the plurality of retainers. Two position-limiting pairs are symmetrically arranged at the end portion of each of the plurality of position-limiting buckling strips, and corresponding ones of the two position-limiting pairs on the adjacent position-limiting buckling strips are opposite to each other to be interlocked with a buckling shoulder on the corresponding one of the plurality of retainers.

In a preferred embodiment, the elastic outer tire tread is symmetrically divided into two petals, and end surfaces of the two petals are configured to be fused or connected to each other after installation.

In a preferred embodiment, the spring tire or the spring wheel comprises two fastening rings. The two fastening rings are disposed on an outside of the elastic outer tire tread and are configured to fix the elastic outer tire tread on the hub.

Compared with the existing techniques, the technical solution has the following advantages.

The present disclosure provides the spring tire or the spring wheel, and the plurality of tapered springs are detachably secured to the hub through the plurality of retainers. The plurality of retainers are configured to be buckled to the hub, enabling rapid replacement of spring components experiencing elastic fatigue during wheel operation. Two side surfaces of a body of each of the plurality of retainers are symmetrically sleeved on two sides of the circumferential surface the hub, effectively addressing the application limitation in spring-based tire systems of insufficient lateral torsional resistance.

### BRIEF DESCRIPTION OF THE DRAWINGS

FIG. 1 illustrates an assembly diagram of the prior art spring-type non-pneumatic wheel.

FIG. 2 illustrates an enlarged partial view of the prior art spring-type non-pneumatic wheel.

FIG. 3 illustrates a front view of Embodiment 1 of the present disclosure.

FIG. 4 illustrates a perspective view of Embodiment 1 of the present disclosure.

FIG. 5 illustrates an exploded view of Embodiment 1 of the present disclosure.

FIG. 6 illustrates an enlarged structural view at Area A1 in FIG. 5.

FIG. 7 illustrates an enlarged structural view at Area A2 in FIG. 5.

FIG. 8 illustrates a detailed assembly diagram of Embodiment 1 of the present disclosure.

FIG. 9 illustrates a front view of Embodiment 2 of the present disclosure.

FIG. 10 illustrates a side view of Embodiment 2 of the present disclosure.

FIG. 11 illustrates a side cross-sectional view of Embodiment 2 of the present disclosure.

FIG. 12 illustrates an exploded view of Embodiment 2 of the present disclosure.

FIG. 13 illustrates an enlarged structural view at Area A3 in FIG. 12.

### DETAILED DESCRIPTION OF THE EMBODIMENTS

The following will clearly and completely describe the technical solutions in the embodiments of the present disclosure with reference to the accompanying drawings. Obviously, the described embodiments are only a portion of the embodiments of the present disclosure, and not all of the embodiments. Based on the embodiments of the present disclosure, all other embodiments obtained by those of ordinary skill in the art without creative work fall within the protection scope of the present disclosure.

In the description of the present disclosure, it should be noted that the terms “upper”, “lower”, “inner”, “outer”, “top”, bottom”, etc. indicate the orientation or positional relationship based on the orientation shown in the drawings. The positional relationship is only for the convenience of describing the present disclosure and simplifying the description, rather than indicating or implying that the referenced device or element must have a specific orientation, be constructed, and be operated in a specific orientation. Therefore, the positional relationship should not be understood as a limitation of the present disclosure. Furthermore, the terms “first”, “second”, etc., are used for descriptive purposes only and are not to be construed as indicating or implying relative importance.

In the description of the present disclosure, it should be noted that terms such as “install”, “provided with”, “sleeved”, “connected”, etc., should be interpreted broadly unless explicitly stated or defined otherwise. For example, “connected” may refer to wall-mounted connections, detachable connections, integral connections, mechanical connections, electrical connections, direct connections, or indirect connections through an intermediary medium. It may also denote internal communication between two components. For those skilled in the art, the specific meanings of the aforementioned terms in the present disclosure may be understood based on specific circumstances.

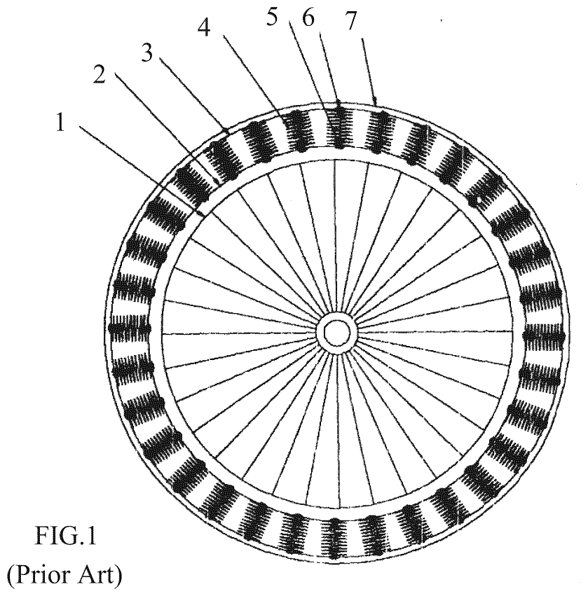

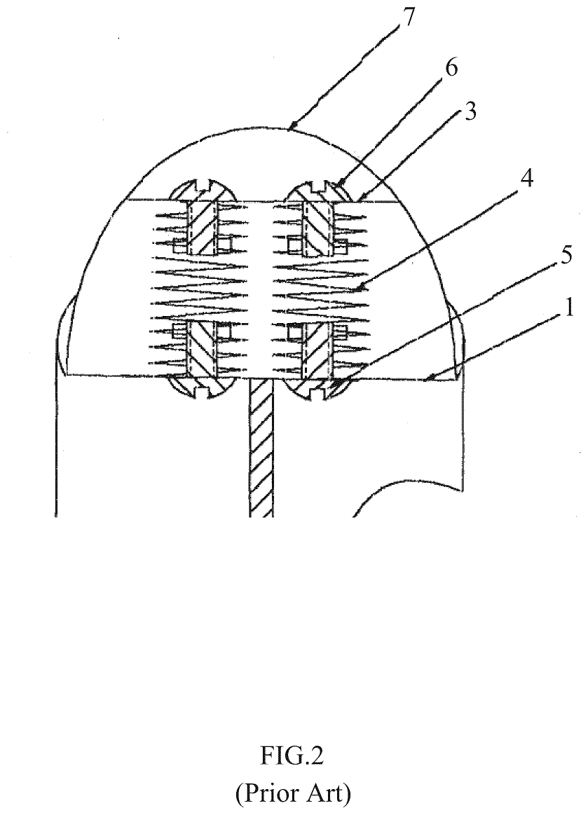

Traditional pneumatic tires use air pressure as a medium to support a vehicle body and have excellent tensile, bending, and collision-resistant buffering properties. However, when punctured by external sharp objects or damaged by other factors, the tire cannot maintain its original pressure state, causing the tire to lose its supporting function. The resulting deterioration in vehicle handling and braking performance may also lead to greater safety hazards. Based on this, non-pneumatic tires that do not require inflation have been introduced on the market. The design of non-pneumatic tires uses elastic fillers or supports to replace the effect of tire pressure, which can avoid safety accidents caused by loss of air pressure or tire blowout during vehicle driving. This type of non-pneumatic tire is divided into solid tires, crush structure tires, and spring tires, among which the spring tires have the most significant stress-bearing performance and durability. Referring to FIGS. 1 and 2, a spring-type non-pneumatic tire is shown in the background technology (showing an ordinary wheel steel rim 1, an inner spring plate steel rim 2, an outer spring plate steel rim 3, a plurality of coil springs 4, a plurality of fasteners 5, a plurality of fasteners 6, and a wheel rubber 7). This spring-type non-pneumatic tire is based on an ordinary wheel and uses the plurality of coil springs 4 and the outer spring plate steel rim 3 to replace an inner tube of an ordinary wheel to make the tire body have a shock-absorbing effect. However, a coil spring of the plurality of coil springs 4 on a circumferential surface of the spring-type non-pneumatic tire is restricted by the inner spring plate steel rim 2 and the outer spring plate steel rim 3, and there are problems such as poor axial torsion resistance and low radial coordination efficiency in a structural connection of the spring-type non-pneumatic tire. The spring-type non-pneumatic tire is unable to buffer and decompose the force. There is also a phenomenon that once a local spring of the plurality of coil springs 4 is damaged, normal use of the entire spring-type non-pneumatic tire will be affected.

### Embodiment 1

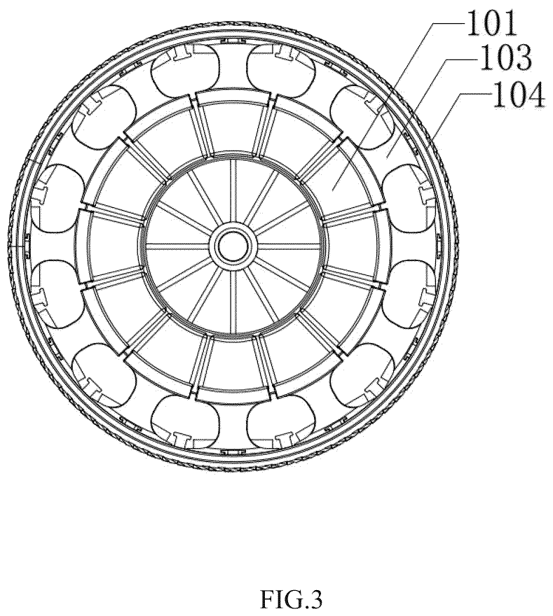

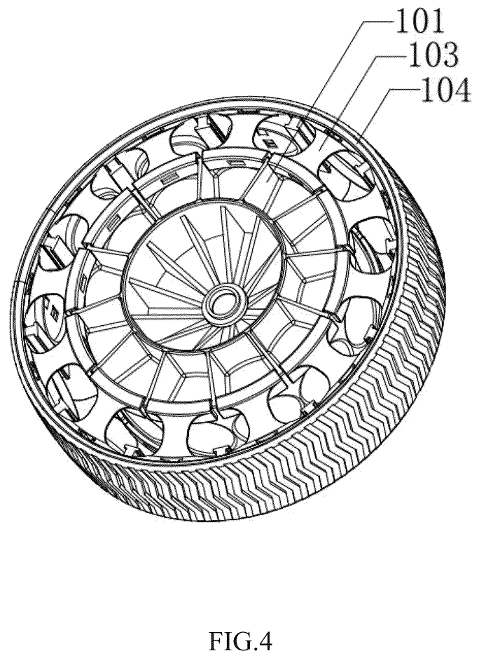

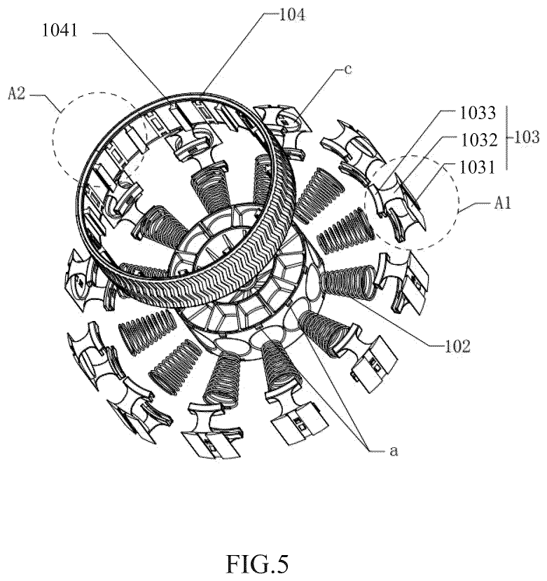

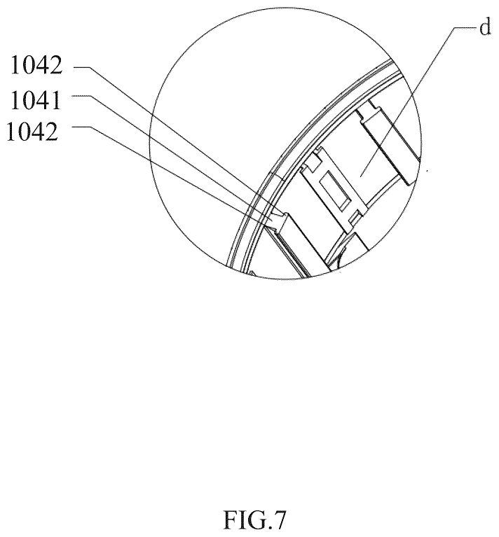

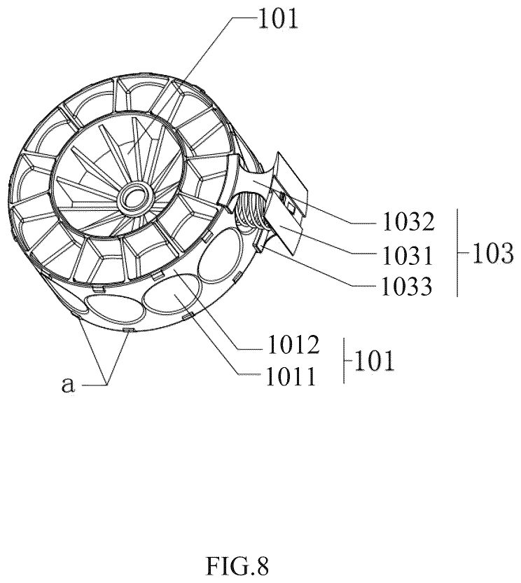

In order to overcome the above technical problems, the present embodiment of the present disclosure provides a spring wheel. Referring to FIGS. 3 to 8, the spring wheel comprises a hub 101, a plurality of tapered springs 102, a plurality of retainers 103, and an elastic outer tire tread 104. The hub 101 comprises a plurality of first buckling grooves 1011 evenly distributed in a circumferential direction of the hub 101. A first end of each of the plurality of tapered springs 102 is disposed in an accommodating cavity of a corresponding one of the plurality of first buckling grooves 1011, and a second end of each of the plurality of tapered springs 102 supports a corresponding one of the plurality of retainers 103 in a direction away from the corresponding one of the plurality of first buckling grooves 1011. Each of the plurality of retainers 103 comprises two side surfaces symmetrically arranged relative to each other, and the two side surfaces converge at a predetermined position in a radial direction of the hub 101 to form a body of the corresponding one of the plurality of retainers 103. An inner side surface of each of the plurality of retainers 103 is pressed on and covers a corresponding one of the plurality of tapered springs 102, and the inner side surface of each of the plurality of retainers 103 is buckled to and connected to two rib rings 1012 of a circumferential surface of the hub 101. An outer side surface of each of the plurality of retainers 103 abuts an inner side surface of the elastic outer tire tread 104.

The two side surfaces of the body of each of the plurality of retainers 103 are sleeved on two sides (i.e., the two rib rings 1012) of the circumferential surface of the hub 101 to solve an application limitation of the above-mentioned spring-type non-pneumatic tire due to a poor axial torque resistance of the plurality of coil springs 4. Specifically, each of the plurality of retainers 103 comprises a buckling shoulder 1031, two buckling arms 1032, and two buckling claws 1033 from outside to inside along the radial direction of the hub 101. The two buckling claws 1033 are symmetrically sleeved on the two sides of the circumferential surfaces of the hub 101. A first end of each of the two buckling arms 1032 is fixedly connected to a corresponding one of the two buckling claws 1033, and a second end of each of the two buckling arms 1032 extends away from the corresponding one of the two buckling claws 1033 to be fixedly connected to the buckling shoulder 1031. The buckling shoulder 1031 is arranged on an outer circumferential surface perpendicular to an arrangement direction of the two buckling claws 1033 and having a certain height difference relative to the two buckling claws 1033. An outer side surface of the buckling shoulder 1031 abuts the inner side surface of the elastic outer tire tread 104, and an inner side surface of the buckling shoulder 1031 presses the corresponding one of the plurality of tapered springs 102 radially inward. The plurality of tapered springs 102 disposed in a position-limited space formed between the plurality of first buckling grooves 1011 and the plurality of retainers 103 are pre-compressed springs. A small end face of each of the plurality of tapered springs 102 is embedded in the corresponding one of the plurality of first buckling grooves 1011, a large end face of each of the plurality of tapered springs 102 is embedded in a third buckling groove c on the inner side surface of the buckling shoulder 1031, and the corresponding one of the plurality of tapered springs 102 supports the buckling shoulder 1031 with a predetermined initial compression force.

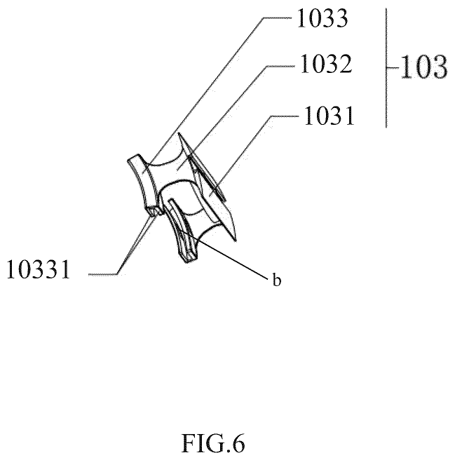

Since the buckling shoulder 1031 of each of the plurality of retainers 103 is pressed on the corresponding one of the plurality of tapered springs 102 and each of the plurality of retainers 103 is connected to the hub 101 by the two buckling claws 1033, compared with other connection structures, a buckling connection has a characteristic of being able to be disassembled and assembled without auxiliary tools, and the plurality of tapered springs 102 that have elastic fatigue during use of the spring wheel can be replaced more conveniently and quickly. A structure for realizing the buckling connection comprises an inserting part and a receiving part. The inserting part is configured as the two rib rings 1012 on the circumferential surface of the hub 101, and the receiving part is configured as two buckling strips 10331 on each of the two buckling claws 1033. The two buckling strips 10331 are symmetrically arranged on a corresponding one of the two rib rings 1012 and disposed on an inner side surface of a corresponding one of the two buckling claws 1033 adjacent to the hub 101. A detailed structure is shown in FIG. 6. The two buckling strips 10331 are parallel to and spaced apart from each other at a predetermined distance, a first side of each of the two buckling strips 10331 is fixedly connected to the inner side surface of the corresponding one of the two buckling claws 1033, and a second side of each of the two buckling strips 10331 extends toward the circumferential surface of the hub 101.

Considering that dynamic loads received by the spring wheel during driving directly affect engagement stability of the inserting part and the receiving part, the present embodiment provides a position-limiting member and a position-limiting matching member respectively on the inserting part and the receiving part. The position-limiting member is an inserting block a disposed on the inserting part, and the position-limiting matching member is an inserting groove b located on the receiving part. When the inserting part and the receiving part are buckled to each other, the inserting block a is inserted into and interlocked with the inserting groove b, thereby fixing a relative installation position and preventing the inserting part and the receiving part from relative slipping due to excessive external extrusion force acting on the buckling shoulder 1031, so that instability and damage of the plurality of retainers 103 can be prevented.

A plurality of position-limiting buckling strips 1041 are evenly distributed on the inner side surface of the elastic outer tire tread 104 facing the plurality of retainers 103. Root portions of the plurality of position-limiting buckling strips 1041 are connected to the inner side surface of the elastic outer tire tread 104, and end portions of the plurality of position-limiting buckling strips 1041 extend toward the plurality of retainers 103. Adjacent position-limiting buckling strips 1041 of the plurality of position-limiting buckling strips 1041 form a fourth buckling groove d for inhibiting a relative swing of one end of the corresponding one of the plurality of retainers 103 away from of the hub 101. For this structure, two position-limiting pairs 1042 are symmetrically arranged at an end portion of each of the plurality of position-limiting buckling strips 1041. Corresponding ones of the two position-limiting pairs 1042 on the adjacent position-limiting buckling strips 1041 forming the fourth buckling groove d are opposite to each other to be interlocked with the buckling shoulder 1031 on the corresponding one of the plurality of retainers 103, so as to fix a relative position of the elastic outer tire tread 104 and the hub 101.

### Embodiment 2

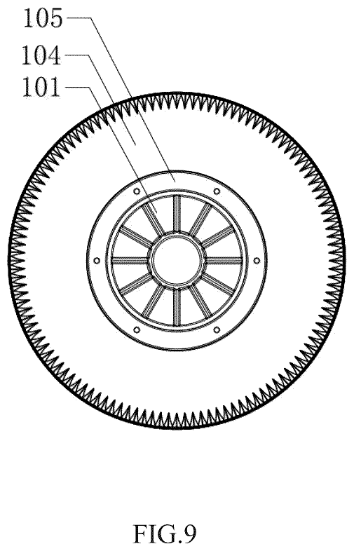

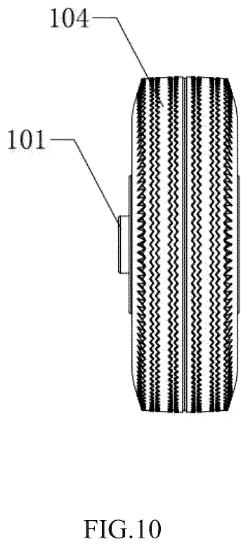

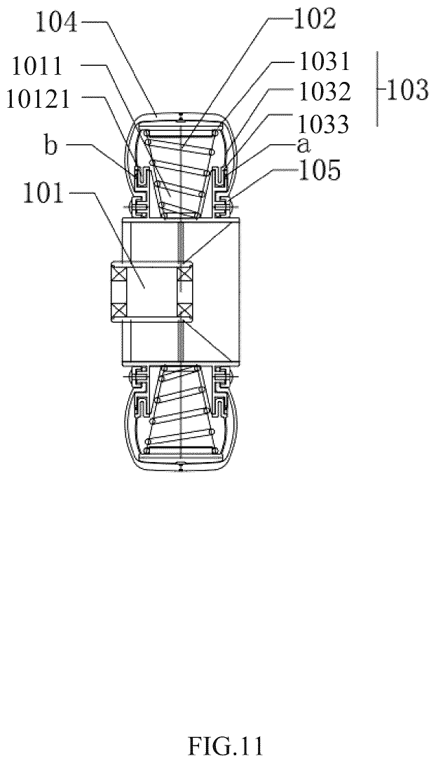

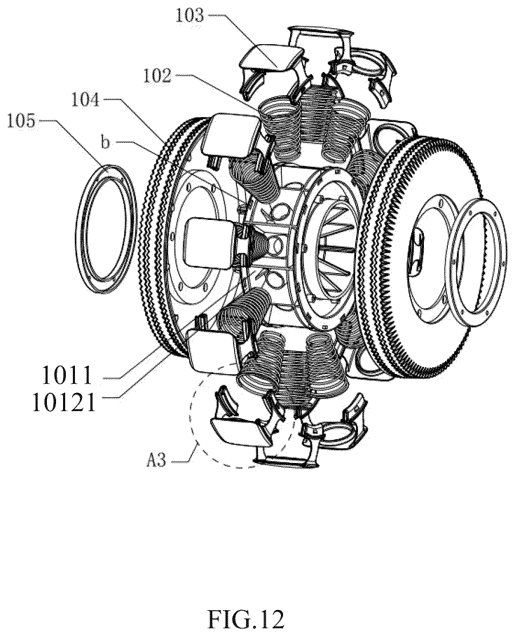

Referring to FIGS. 9-13, the present embodiment of the present disclosure provides a spring wheel, and the spring wheel comprises a hub 101, a plurality of tapered springs 102, a plurality of retainers 103, an elastic outer tire tread 104, and two fastening rings 105. The difference from the above-mentioned Embodiment 1 is described as follow.

First, the elastic outer tire tread 104 described in this embodiment is symmetrically divided into two petals, and end surfaces of the two petals can be fused or connected to each other after installation. In addition, the two fastening rings 105 are added, and the two fastening rings 105 are disposed on an outside of the elastic outer tire tread 104 and are configured to fix the elastic outer tire tread 104 on the hub 101.

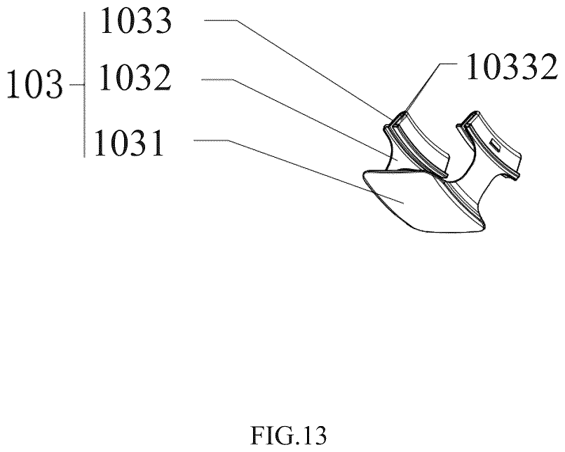

Secondly, a form of components of the buckling connection between the plurality of retainers 103 and the hub 101 is different. Referring to FIG. 13, the buckling connection is also achieved by an inserting part and a receiving part, but the inserting part is constructed as a U-shaped part 10332 on each of the two buckling claws 1033, and the receiving part is constructed as a second buckling groove 10121 arranged on the circumferential surface of the hub 101. The two buckling claws 1033 and the second buckling groove 10121 are still respectively provided with an inserting block a and an inserting groove b interlocked with each other.

The aforementioned embodiments are merely some embodiments of the present disclosure, and the scope of the disclosure is not limited thereto. Thus, it is intended that the present disclosure cover any modifications and variations of the presently presented embodiments provided they are made without departing from the appended claims and the specification of the present disclosure.

What is claimed is:

1. A spring tire or a spring wheel, comprising:
a hub,
a plurality of tapered springs,
a plurality of retainers, and
an elastic outer tire tread, wherein:
the plurality of tapered springs are pre-compressed and mounted on the hub through the plurality of retainers,
inner side surfaces of the plurality of retainers are pressed on and abut the plurality of tapered springs,
the inner side surfaces of the plurality of retainers are buckled to the hub, and
outer side surfaces of the plurality of retainers abut an inner side surface of the elastic outer tire tread.

2. The spring tire or the spring wheel according to claim 1, wherein:
each of the plurality of retainers comprises two buckling claws symmetrically sleeved on a circumferential surface of the hub, a buckling shoulder perpendicular to the two buckling claws and having a height difference relative to the two buckling claws, and two buckling arms, and
two ends of each of the two buckling arms are respectively connected to a corresponding one of the two buckling claws and the buckling shoulder.

3. The spring tire or the spring wheel according to claim 2, wherein:
the buckling shoulder presses a corresponding one of the plurality of tapered springs radially inward,
the plurality of tapered springs are pre-compressed springs, and
the plurality of tapered springs generate elastic resetting forces due to being pressed by the buckling shoulders of the plurality of retainers.

4. The spring tire or the spring wheel according to claim 1, wherein:
a buckling connection between each of the plurality of retainers and the hub is achieved by an inserting part and a receiving part,
the inserting part is configured as two rib rings on a circumferential surface of the hub, and
the receiving part is configured as one or more buckling strips on each of two buckling claws.

5. The spring tire or the spring wheel according to claim 4, wherein:
the one or more buckling strips are two buckling strips, and
the two buckling strips are symmetrically arranged on a corresponding one of the two rib rings and disposed on an inner side surface of a corresponding one of the two buckling claws adjacent to the hub.

6. The spring tire or the spring wheel according to claim 1, wherein:
a buckling connection between each of the plurality of retainers and the hub is achieved by an inserting part and a receiving part,
the inserting part is configured as a U-shaped part on each of two buckling claws, and
the receiving part is configured as a second buckling groove arranged on a circumferential surface of the hub.

7. The spring tire or the spring wheel according to claim 4, wherein:
a position-limiting member and a position-limiting matching member are respectively located on the inserting part and the receiving part, and
when the inserting part and the receiving part are buckled to each other, the position-limiting member and the position-limiting matching member are interlocked with each other.

8. The spring tire or the spring wheel according to claim 7, wherein:
the position-limiting member is an inserting block disposed on the inserting part, and
the position-limiting matching member is an inserting groove located on the receiving part.

9. The spring tire or the spring wheel according to claim 3, wherein:
a side of the buckling shoulder of each of the plurality of retainers facing the corresponding one of the plurality of tapered springs comprises a third buckling groove configured to be sleeved on the corresponding one of the plurality of tapered springs.

10. The spring tire or the spring wheel according to claim 9, wherein:
a small end face of each of the plurality of tapered springs is embedded in a corresponding one of a plurality of first buckling grooves on the hub,
a large end face of each of the plurality of tapered springs is embedded in a corresponding one of the third buckling grooves, and
each of the plurality of tapered springs supports a corresponding one of the buckling shoulders with a predetermined initial compression force.

11. The spring tire or the spring wheel according to claim 1, wherein:
a plurality of position-limiting buckling strips are evenly distributed on the inner side surface of the elastic outer tire tread facing the plurality of retainers,
adjacent position-limiting buckling strips of the plurality of position-limiting buckling strips form a fourth buckling groove, and
the fourth buckling groove is configured to inhibit a relative swing of one end of a corresponding one of the plurality of retainers away from of the hub.

12. The spring tire or the spring wheel according to claim 11, wherein:
root portions of the plurality of position-limiting buckling strips are connected to the inner side surface of the elastic outer tire tread,
end portions of the plurality of position-limiting buckling strips extend toward the plurality of retainers,
two position-limiting pairs are symmetrically arranged at the end portion of each of the plurality of position-limiting buckling strips, and
corresponding ones of the two position-limiting pairs on the adjacent position-limiting buckling strips are opposite to each other to be interlocked with a buckling shoulder on the corresponding one of the plurality of retainers.

13. The spring tire or the spring wheel according to claim 1, wherein:
the elastic outer tire tread is symmetrically divided into two petals, and
end surfaces of the two petals are configured to be fused or connected to each other after installation.

14. The spring tire or the spring wheel according to claim 13, comprising:
two fastening rings, wherein:
the two fastening rings are disposed on an outside of the elastic outer tire tread and are configured to fix the elastic outer tire tread on the hub.

15. The spring tire or the spring wheel according to claim 5, wherein:
a position-limiting member and a position-limiting matching member are respectively located on the inserting part and the receiving part, and
when the inserting part and the receiving part are buckled to each other, the position-limiting member and the position-limiting matching member are interlocked with each other.

16. The spring tire or the spring wheel according to claim 15, wherein:
the position-limiting member is an inserting block disposed on the inserting part, and
the position-limiting matching member is an inserting groove located on the receiving part.

17. The spring tire or the spring wheel according to claim 6, wherein:
a position-limiting member and a position-limiting matching member are respectively located on the inserting part and the receiving part, and
when the inserting part and the receiving part are buckled to each other, the position-limiting member and the position-limiting matching member are interlocked with each other.

18. The spring tire or the spring wheel according to claim 17, wherein:
the position-limiting member is an inserting block disposed on the inserting part, and
the position-limiting matching member is an inserting groove located on the receiving part.
